(19) United States
(12) Patent Application Publication
(10) Pub. No.: US 2020/0402161 A1
(43) Pub. Date: Dec. 24, 2020

(54) SYSTEM AND METHODS FOR TRANSPARENT UNDERWRITING

(71) Applicant: HALLEMAN BRADLEY INC., Santa Monica, CA (US)

(72) Inventors: Zach Bruhnke, Los Angeles, CA (US); Dmitry Gritskevich, San Francisco, CA (US); Stephen Germain Cassiere, III, Leander, TX (US); Yu Xuan Zheng, Vancouver B.C. (CA); William Lessard, III, Culver City, CA (US)

(21) Appl. No.: 16/905,614

(22) Filed: Jun. 18, 2020

Related U.S. Application Data
(60) Provisional application No. 62/863,723, filed on Jun. 19, 2019.

(51) Int. Cl. G06Q 40/02; G06Q 40/04; H04L 29/06

(52) U.S. Cl. CPC G06Q 40/025; H04L 67/42; G06Q 40/04

(57) ABSTRACT

The disclosed embodiments relate to performance of no application account tasks. A no application account task can include opening a new account for a client. A provider may retrieve client information associated with a client and determine whether the client is approved for one or more products offered by the provider. The new account can be generated by mapping information relating to the new account with a client identifier associated with the client. The client interface can be updated to include a display of the first product that is capable of being selected by the client or to confirm that a new account has been created.

### CROSS-REFERENCE TO RELATED APPLICATIONS

The present application claims priority to U.S. Provisional Patent Application No. 62/863,723, titled “IMPLEMENTING A NO APPLICATION UNDERWRITING PROCESS,” and filed Jun. 19, 2019, wherein the entirety of which is incorporated by reference hereto.

### BACKGROUND

Many actions of people are tracked using various identifiers associated with each person (e.g., a set of credentials, a government-issued identification number, personal information). For example, the credit history of a person may be tracked by a credit-reporting entity by associating credit-effecting events relating to the person with a government-issued identification number that identifies that person. Some firms may associate a score or rating to a person's tracked credit-effecting events to identify the relative quality of the tracked events. For example, a credit-reporting entity may track all credit-effecting events and issue a credit score for a person representing the creditworthiness of that person.

Various entities may use scores associated with a person to make decisions for that person. As an example, a creditor may use a credit score associated with a person to decide whether the person is credit-worthy and should be issued a loan or be eligible for further underwriting). Usually, an entity receives an application for services from an applicant and the entity may use the application information to make a decision on whether to provide the requested services.

In many cases, in order to make such a decision, a provider (e.g., a creditor) may retrieve multiple sets of information from various sources. For example, a creditor (or “underwriter”) may transmit a request for a credit score for a person from multiple credit reporting entities. Additionally, the underwriter may transmit requests for other information from various sources to determine a creditworthiness of the person.

### BRIEF DESCRIPTION OF THE DRAWINGS

FIG. 1 illustrates an example environment in which the present embodiments can be implemented.

FIG. 2 is a block diagram of an example client interface.

FIG. 3 illustrates an example block diagram of a customer device and a provider device.

FIG. 4 illustrates an example flow process for determining whether a client is approved for a product via a decision engine.

FIG. 5 illustrates an example flow diagram to enable a client to implement a no application account task procedure.

FIG. 6 is a flow diagram of a process to open an account for a client based on a transparent underwriting process.

FIG. 7 illustrates an example method for dynamic creation of a new account for a client.

FIG. 8 is a block diagram illustrating an example of a processing system in which at least some operations described herein can be implemented.

The drawings and tables depict various embodiments for illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

Many actions taken by individuals can be monitored/tracked using various identifiers associated with each person (e.g., credentials, government-issued identification number, personal information). For example, the credit history of a person (or client) may be tracked by associating events effecting the credit history of the person with a government-issued identification number identifying the person. Some firms may associate a score or rating to a person's tracked credit-effecting events to identify the relative quality of the tracked events. For example, a credit-reporting entity may track all credit-effecting events and issue a credit score for a person representing the creditworthiness of that person.

Various entities may use scores associated with a person to make decisions for that person. As an example, an underwriting company may inspect a credit score associated with a person to decide whether the person is credit-worthy and should be issued a loan (or an underwriting process). Generally, an entity may receive an application for services from a client, and the entity may make a decision on whether to accept the terms of the application for that client based on information relating to the applicant.

In order to make such a decision, a provider (e.g., a creditor) may retrieve multiple sets of information from various sources. For example, a creditor (or “underwriter”) may transmit a request for a credit score for a person from multiple credit reporting entities. Additionally, the underwriter may transmit requests for other information from various sources to determine a creditworthiness of the person.

The process of receiving the relevant information at the underwriter may result in an inefficient use of computer and computer network resources. For example, the provider may transmit multiple requests for information across a network, where the external entities transmit data-intensive messages including the requested information over a long time period. The provider may repeat this process multiple times to receive the requested information from external entities, update the information, or confirm the received information. Particularly, when requesting information relating to multiple clients, this formal process of receiving requested information may be an inefficient use of computing and network resources. In many cases, information may be delayed in being transmitted to the provider, slowing the overall time to receive the requested information and make a decision on behalf of a client.

This process may include transmitting sensitive information (e.g., client personal information, account numbers) between devices via networks. For example, to obtain a credit report of a client, personal information of the client may be transmitted between multiple nodes to retrieve the credit report. However, this may leave sensitive information vulnerable to unauthorized access. For instance, an intermediary device may access client information being transmitted across a network. Accordingly, it may be desirable to lessen a number of instances of transmitting client data between devices in the network

Further, in many cases, a company's webpage can enable a person to request an account or obtain approval for a product or service. However, if a person makes such a request, the webpage may redirect the person another webpage or website to provide other information so the company providing the product or service can determine whether the person is eligible for a new account or if the person will be approved for a product or service. Redirecting the person from a webpage to another webpage or website may frustrate the user's experience because the person is unable to perform various actions on the same webpage or using a common interface.

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts that are not particularly addressed herein. These concepts and applications fall within the scope of the disclosure and the accompanying claims.

Embodiments may be described with reference to particular computer programs, system configurations, networks, etc. However, those skilled in the art will recognize that these features are equally applicable to other computer program types, system configurations, network types, etc. For example, although the term “Wi-Fi network” may be used to describe a network, the relevant embodiment could be deployed in another type of network.

Moreover, the present embodiments can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program a computing device to perform processing tasks as described herein.

### Terminology

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, may refer to any connection or coupling, either direct or indirect, between two or more elements. The coupling or connection between the elements can be physical, digital, logical, or a combination thereof.

References to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”).

The term “based on” is also to be construed in an inclusive sense rather than an exclusive or exhaustive sense. Thus, unless otherwise noted, the term “based on” is intended to mean “based at least in part on.”

The term “module” refers broadly to software components, hardware components, and/or firmware components. Modules are typically functional components that can generate useful data or other output(s) based on specified input(s). A module may be self-contained. A computer program may include one or more modules. Thus, a computer program may include multiple modules responsible for completing different tasks or a single module responsible for completing multiple tasks.

When used in reference to a list of multiple items, the word “or” is intended to cover all of the following interpretations: any of the items in the list, all of the items in the list, and any combination of items in the list.

The sequences of steps performed in any of the processes described herein are exemplary. However, unless contrary to physical possibility, the steps may be performed in various sequences and combinations. For example, steps could be added to, or removed from, the processes described herein. Similarly, steps could be replaced or reordered. Thus, descriptions of any processes are intended to be open-ended.

### System Overview

The present embodiments relate to a dynamic and transparent underwriting process. The process permits a credit providing entity to inspect client-specific data and identify products for which the credit providing entity can offer the client and for which the client would be approved. The credit providing entity can provide the products for which the client is approved to the client via a client interface on a client device. The client can select a product and have the credit providing entity open a new account opened for the client already has provided. The client can select the product by sending a single action by providing a client identifier to the credit provider to request opening of a new account. In response, a system as described herein can update a flag that corresponds to the client to open a new account. The system can assign information associated with the client for the new account and can update relevant database to include this information.

The present system (or simply “provider”) may generate interfaces (e.g., a webpage, mobile application page) for the client that includes the products that the client has been approved based on the credit provider determining that the client information is within a specified range for the products. Upon a selection of a product shown on the display by the client interacting with the client device, the provider may approve the client for access to the product.

A provider (e.g., underwriter) may receive an identifier associated with a client. Based on identifying the client, the provider may transmit a webpage to a device associated with the client. The client device may display information that identifies a product and display an indicator (e.g., a button) that a single action (e.g., a mouse click) that a client may perform to confirm the opening of an account associated with the product. The provider may open/create an account that associates the client to a product selected by the client. Upon creation of the account, a client may access the product (e.g., access funds for a loan).

Further, the present system can generate a series of products for which the client is approved without previous requests from the client. For example, the system can process client information to determine a number of products for which the client is approved. The system can update a client interface to provide a description of the number of products for which the client is approved. The system can automatically enroll the client with the product and provide information related to the product if the client accepts the offer for a product. The client can enroll/subscribe to a product without being redirected from the client interface.

In some embodiments, a method to automatically generate a new account for a client includes generating a client interface to be presented on a client device associated with the client. The client interface can include a webpage/application displaying on a client device that includes client-specific information.

The method can include retrieving client information associated with the client from a client information database based on identifying at least one entry that corresponds with the client. Client information can include various information relating to a client, such as personal information, credit history information, payment information, and active accounts.

The method can also include receiving requested client information from the multiple third-party devices. The method can also include deriving a type of information included in the requested client information. The method can also include storing the requested client information in the client information database based on the derived type of information of the requested client information.

The method can include determining whether the client information is within an approval threshold of a first set of product information for a first product. A first product can include a product offered by the provider (e.g., credit card, mortgage). As an example, the approval threshold can include value(s) (e.g., a credit score value) that allow for the client to be approved for the first product.

In some embodiments, determining whether the client information is within the approval threshold of the first set of product information for the first product further includes inspecting the client information and the first set of product information to identify a number of subsets of client information that correspond to each type of product information included in the first set of product information. As an example, a first type of product information can include credit score information, and the system can retrieve credit score information relating to the client from the client information. The method can include determining whether values included in each subset of client information exceed a threshold value range for each type of product information included in the first set of product information. The method can include determining whether a number of instances of values included in each subset of client information that exceeds the threshold value range for each type of product information included in the first set of product information is greater than a threshold number. The client information may be within the approval threshold of the first set of product information for the first product when the number of instances of values included in each subset of client information that exceeds the threshold value range for each type of product information included in the first set of product information is greater than the threshold number.

In some embodiments, the method includes detecting an indication on the client interface indicating a request for presentation of products on the client interface. The method also includes setting a flag associated with the client identifier, wherein updating the client interface to include a display of the first product that is capable of being selected by the client is performed responsive to identifying the flag associated with the client identifier.

In some embodiments, the client interface includes a series of buttons indicative of no application account tasks capable of being performed for the client. The single action can include a selection of a first button of the series of buttons on the client interface corresponding to generating the new account.

Responsive to determining that the client information is within the approval threshold of the first set of product information for the first product, the method can include updating the client interface to include a display of the first product that is capable of being selected by the client. For example, the display of the first product can include a portion of the interface that provides information relating to the product and can allow for a client to select the first product.

In some embodiments, the method can include presenting a subset of products on the client interface in an order. The first product can be included in the subset of products. The client information may be within approval thresholds of product information for each product of the subset of products.

In some embodiments, the method can include deriving the order of the subset of products based on the product information for each product of the subset of products based on a relevance of each product to the client information and a rating of each product. The products can be provided to the client based on any of a time period, a chronological order, a date that the products are provided, etc.

The method can include detecting a request from the client device to generate the new account for the client, the request comprising a single action on the client interface presented on the client device. The new account can include a first account associated with the first product or a second account that includes an account type that is different than an account type of a primary account associated with the client.

The method can include generating the new account by mapping information relating to the new account with a client identifier associated with the client. In some embodiments, generating the new account can include populating account description fields using client information maintained by the client information database.

The method can include storing the information relating to the new account and the client identifier in an account database.

The method can include updating the client interface to indicate that the new account is available to the client.

### Example Environment Overview

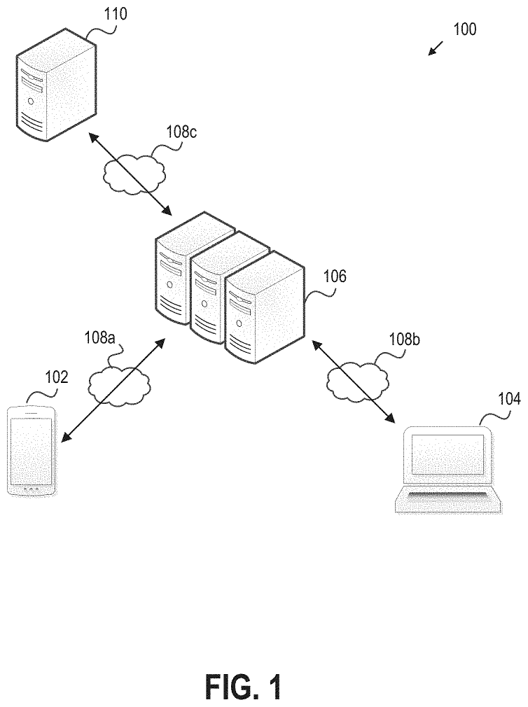

FIG. 1 illustrates an example environment 100 in which the present embodiments can be implemented. The environment 100 can include one or more client devices 102. Each client device 102 can include a network-accessible device (e.g., a smartphone, tablet, computer) capable of presenting a client interface to a client. The client interface can include a webpage/application provided by network-accessible server system 106 that is specific to the client.

As described in greater detail below, the client interface can allow for an individual (e.g., an employee of the vendor) to view account information, take an action (e.g., open a new account, subscribe to a product), etc., without being redirected from the client interface.

The environment can include a provider device 104. The provider device 104 can include a network-accessible device associated with a provider of the products offered to the client. The provider device 104 can allow for a provider to view various data, such as client data, database information, analytics, etc.

The environment 100 can include a network-accessible server system 106. The network-accessible server system 106 can include one or more computing devices (e.g., servers) capable of storing information and performing processing tasks as described herein.

The devices included in the environment 100 can communicate via networks 108a-c. The network(s) 108a-c can include personal area networks (PANs), local area networks (LANs), wide area networks (WANs), metropolitan area networks (MANs), cellular networks, the Internet, etc. Additionally or alternatively, the network-accessible server system 106 can be communicatively coupled to devices device(s) in the environment 100 over a suitable wired/wireless communication protocol.

The network-accessible server system 106 can communicate with a third-party server 110. The third-party server 110 can include a device associated with a third party (e.g., a client information storage node, a credit monitoring node). The network-accessible server system 106 can connect with third-party server 110 via an application programming interface (API), a plugin, etc. The network-accessible server system 106 and third-party server 110 can securely communicate via a suitable encryption technique. For example, the network-accessible server system 106 can securely retrieve credit information from the third-party server 110.

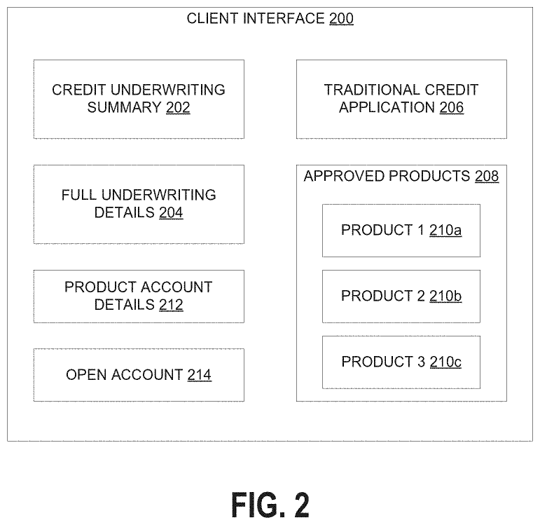

FIG. 2 is a block diagram of an example client interface 200. The client interface can represent a display (e.g., a webpage, mobile application page) executing on a client device (e.g., smartphone, computer). The webpage may include at least one product that a client may select on the webpage and be approved for the product without initiating a formal application process.

In some embodiments, a network-accessible server system 106 (e.g., a server or series of interconnected servers) may transmit the webpage to a client device via a network. In another embodiment, the network-accessible server system 106 may transmit the webpage to a mobile application executing on the client device. As noted above, the network-accessible server system 106 may transmit a webpage with information that is specific or unique to a client. For example, the network-accessible server system 106 may transmit a webpage that only includes products that the client is pre-qualified for.

As shown in FIG. 2, the display may include a credit underwriting summary 202 associated with the client. The credit underwriting summary 202 may include a report or dashboard displaying various information relating to the credit of the client. Information included in the credit underwriting summary may include a credit score from various entities (or “credit bureaus”), other personal indicators as to credit-worthiness, a categorical credit rating (e.g., “excellent,” “good,” “average,” “poor”), a graphical presentation of any credit information (e.g., a color rating for a credit score).

The display may include full underwriting details 204. Full underwriting details may include detailed information relating to anything shown in the credit underwriting summary. The full underwriting details may be retrieved based on an indication for the full underwriting details from the customer device. The display/webpage may include a button or link that, when selected, shows the full underwriting details.

The client interface 200 may include a button to initiate an application process (e.g., traditional credit application 206). The application process may include the submission of application materials to the provider, where the provider can approve or deny the application based on the application materials provided by the applicant. The display may include a button or link that directs the client to a webpage that includes an application for a product offered by the provider. As an example, the application process may be for a loan, where the provider is an underwriter issuing the loan to the applicant based on credit information relating to the applicant. In some embodiments, the application may not be complete and reviewed by the provider until a signature is provided by the client via the webpage or via another method. Accordingly, the client may be prompted on the application to provide a signature on the display using a digital signature or a touchscreen-based signature.

The display may include one or more products that are available to the user (e.g., available products 208). In the embodiment as shown in FIG. 2, a set of approved products 208 can include a first product 210a, a second product, 210b, a third product 210c, etc. An example of a product may include a loan with terms relating to the loan (e.g., the amount to be loaned, interest rates, terms and conditions). In some embodiments, the products displayed on the webpage may include products that the client is pre-approved. As an example, any product listed on the display may be a no application (or “one-click”) credit issuance or loan facility account creation. Each product on the webpage may include any of a product number, a product summary/description, a value associated with the product, etc.

The display may include product account details 212. The details 212 may include detailed information relating to the products available to the user. Examples of such details include terms and conditions, an annual percentage rate (APR), provider information (e.g., name, contact information), etc.

The display can allow for a new account to be opened (e.g., open account 214). The new account can be for any of a variety of account types (e.g., checking, savings, credit card, brokerage). An open account button can allow for a client to open a new account in a single action (e.g., a single click). In some instances, the new account is a secondary account opened on behalf of a client that has previously opened a primary account. A primary account can include a first account opened for a client, and the secondary account can be a newly generated account for the client. The system can process client information to open a new account, as is described in greater detail below.

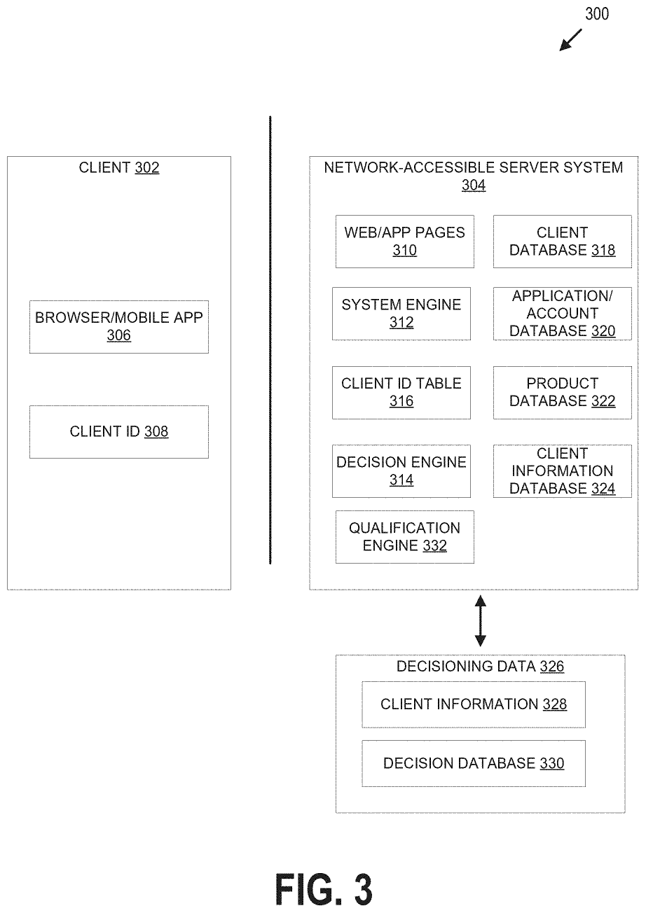

FIG. 3 illustrates an example block diagram 300 of a customer device and a provider device. As shown in FIG. 3, a client device 302 may communicate with a provider device 304 via a network (e.g., the internet).

The client device may include a web browser/mobile app 306 configured to facilitate communications over a network such as the internet and display a webpage on a display of the customer device. The customer device may store and transmit a customer identifier 308 (e.g., a credential, number, value, internet protocol (IP) address, etc.) associated with the customer that identifies the customer.

A network-accessible server system 304 may include a device (e.g., a server) or series of interconnected server associated with a provider (e.g., an underwriter), such as network-accessible server system 106 as described with respect to FIG. 1. The network-accessible server system 304 may include information to render a webpage for a client (e.g., web/app pages 310). The web/app pages 310 can include template web pages to render for various client devices and the network-accessible server system 304 can populate the template web pages with client-specific data. The webpage may be transmitted to a client device 302 via a network (e.g., the internet).

The network-accessible server system 304 can include a system engine 312 may receive a Hypertext Transfer Protocol (HTTP) request to access a webpage or application page associated with the customer identified by a Uniform Resource Locator (URL) and provide the pages to the customer device. The network-accessible server system 304 may include information associated with a plurality of customers, where information associated with each customer is identifiable by a customer identifier.

The network-accessible server system 304 may include a client database 318. The client database 318 may include a listing of client or potential client associated with the provider. The clients in the database 318 may be identified by identifiers provided by each client. The client database 318 can include entries associated with a client, wherein the network-accessible server system 304 can retrieve client-specific information from the client database 318 to open an account or provide products for a client as described herein.

The network-accessible server system 304 may include an application/account database 320. The account database 320 may include a listing of all accounts and applications maintained by the provider. The account database 320 may include information relating to each account, such as a customer identifier associated with the account. The network-accessible server system 304 can retrieve account information and/or application information relating to a client from account database 320.

The network-accessible server system 304 may include a product database 322. The product database may include various products (e.g., loans, new accounts, credit cards, mortgages) offered by the provider and other information relating to the product (e.g., terms, interest rates, qualification information).

The network-accessible server system 304 may include a client information database 324. The client information database 324 may include personal identification and underwriting information associated with various clients.

The network-accessible server system 304 may include a client identifier table 316 associating each customer to a known customer identifier. The client identifier table 316 may include a listing of all client and applicants and a client identifier associated with each client/applicant in order to identify a client.

The network-accessible server system 304 may include a decision engine 314. The decision engine 314 may process product decisions based on client information maintained by any of the client information database 324 and client database 318. As an example, the decision engine 314 may inspect information associated with a client, compare the information against information associated with one or more products, and determine whether the client is approved for any of the products based on the client information.

A qualification engine 332 can include information for qualifying users for specific products. For example, qualification engine 332 can include a qualification database for storing qualifying information (e.g., client information, product information, products that a client is approved).

The network-accessible server system 304 can retrieve decisioning data 326 that can include data used for making decisions (e.g., determine whether a client is approved for a product). The decisioning data 326 can include client information 328 that includes a listing of information relating to the client. The decisioning data 326 can also include a decision database 330 that includes information relevant to making approval decisions. For example, the decision database 330 can include product information, user information, rules for approving clients for a product, etc.

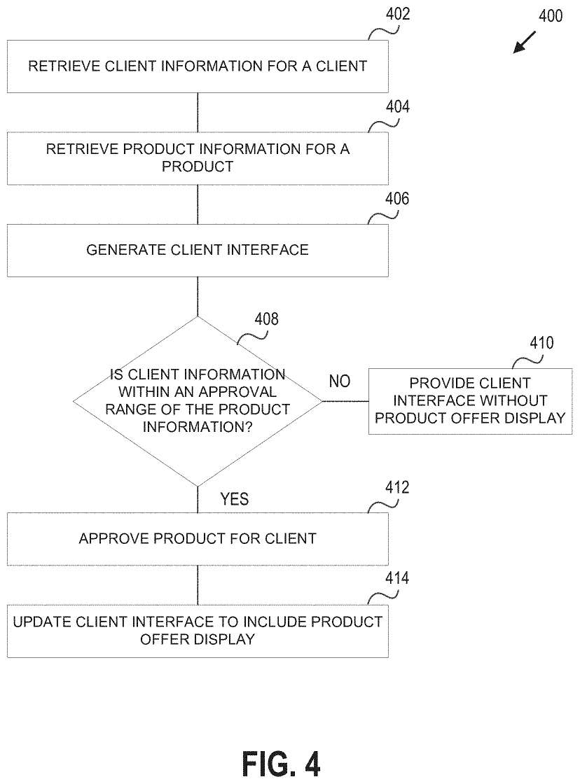

FIG. 4 illustrates an example flow process 400 for determining whether a client is approved for a product via a decision engine. The decision engine (e.g., decision engine 414) may retrieve information associated with a client (block 402). Examples of information associated with a client may include credit information (e.g., a credit score), personal information, tracked data stored by the provider, etc.

In some embodiments, retrieving the client information may include inspecting various databases (e.g., client information database 424, client database 418) for information associated with a client or client identifier.

In some embodiments, retrieving the client information includes requesting client information from external sources over a network. For example, a network-accessible server system may transmit a request for credit information from a third-party credit reporting device based on a client identifier indicative of the client. Retrieving the client information may allow for the provider device to periodically store/update a plurality of client data for the decision engine to make accurate decisions.

The decision engine may retrieve information associated with a first product (block 404). Information associated with a first product may include terms such as a value, interest rate, etc. The information associated with the first product may include a score, rating, or series of scores representing a specified range of client numbers/information that would represent allowable client information. The first product information may be predetermined or specified by an authorized entity associated with the provider.

The system can generate a client interface to be presented on a client device (block 406). The client interface can be generated based on template webpages/app pages maintained by the network-accessible server system. As noted below, the client interface can be populated with client-specific information. For example, if a client is approved for a product, the client interface can be updated to show an offer display offering the product to the client.

The decision engine may determine whether the client information is within an approval range of the product information (block 408). This can be indicative of whether the client, based on client-specific information/values, is approved for the product. In some instances, the decision engine may determine whether the client information includes value(s) that are within a specified range associated with the product.

As an example, the client may include a retrieved credit score of 680. The first product may have a product qualification range (i.e., an acceptable range of credit scores to be approved for the product) of a credit score between 660 and 800. In this example, the client's credit score is within the specified range, and the client may be approved to access the product (block 412). Conversely, if the credit score is 600, the credit score may be outside the specified range and the decision engine may prevent the client from accessing the product (block 410).

Multiple numbers, values, pieces of information, etc. may be inspected and may provide weight in determining whether the client information is within the threshold similarity to the product information. For instance, a set of rules may be used to determine whether a combination of various client-specific features indicates that the client is within the approval range for a product. This can include aggregating historical credit-based information, wage information, account history information, etc., and processing the aggregated information according to rule(s) maintained by the network-accessible server system.

In some embodiments, the network-accessible server system may track events and interactions relating to a client and rate the tracked events. For example, if the client previously agrees to a loan from a provider, the provider can track the payment history and interaction with the client. Based on these interactions, the network-accessible server system may derive a rating or score unique to the client that represents the quality of the interactions between the client and the provider. This rating/score may be utilized in determine whether the client is approved to access a product. In some embodiments, the decision engine may utilize machine learning, neural networks, artificial intelligence, etc. to determine whether client information is within the specified approval range for each product.

As noted in block 412, the client may be approved and allowed to access a product if the client information is within an approval range of the product information. Such approval may instruct the provider device to open an account for the client or set a flag that the client is pre-approved or approved for the product. The product approved may be viewable by the client on a display of available products.

The system can update the client interface to include a display for the product offer (block 414). The product offer display can include information (e.g., a logo, text, a description of the product) describing a product that the client is approved. For example, if a product approved for the client is a credit card, the product offer display can include a name of the credit card, terms of the credit card, benefits, etc. This process can be repeated for each product associated with a provider (e.g., each product included in the product database). In some instances, a number of approved products can be presented on the client interface in a specific order (e.g., based on a rating, relevance to the client).

In some embodiments, the determination of whether the client information is within the approval range for each product offered by the provider may be made independent of receipt of any application for the product from a client. In other words, the client may be approved or prevented from accessing a product without the client requesting a formal application process from the provider. This may increase user experience, as it may decrease the time between requesting a product and accessing the product. Further, this may increase computer network efficiency, as a single indication from a client to accept a pre-approved product on a webpage may facilitate the generation of a new account for the client.

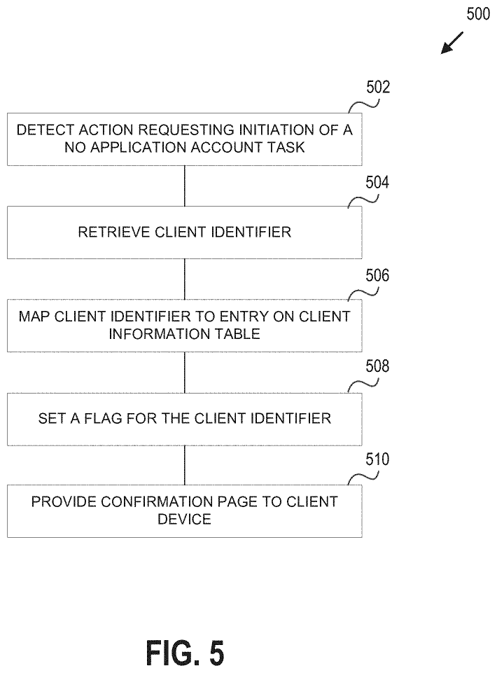

FIG. 5 illustrates an example flow diagram 500 to enable a client to implement a no application account task procedure. A no application account task can include any of opening a new account for a client or approving a client for a product based on an action by the client without performing a traditional application process.

To implement the no application account task, a provider device (e.g., network accessible server system) can detect an action by the client requesting initiation of the no application account task (block 502). For example, the action can include a single click of a button on a client interface requesting a new account be opened for a client. As another example, the action can include a client indication to accept an offer for a product approved for the client. The client interface on a client device can include a listing of account actions that can be taken with respect to a client account, and initiation of the no application account task can be based on a selection of any of the account actions.

The method may include retrieving the client identifier from the client (block 504). The client identifier may be received over a network using a suitable wired/wireless communications protocol.

The method may include mapping the client identifier to a client by mapping the client identifier to a listing on a client table (block 506). Mapping the client identifier to a client may identify a client and facilitate retrieval of other information associated with the client.

The method may include setting a flag for the client/client identifier (block 508). The provider may set a flag in the client table indicating that a no application account task is enabled for the associated client ID. The flag may be a tag or indicator indicating that the client is enabled to utilize no application account tasks. The provider may inspect the client identifiers for flags to determine which clients have enabled no application account task. In some embodiments, the decision engine may decide which available products are pre-approved to the client based on identifying the flag associated with the client.

The method may include transmitting a return confirmation page to the client (block 510). The provider system may send a confirmation to the client system. Accordingly, in a next time a client attempts to apply for a product, the provider may associate the client with a new client identifier that indicates that no application account tasks are enabled.

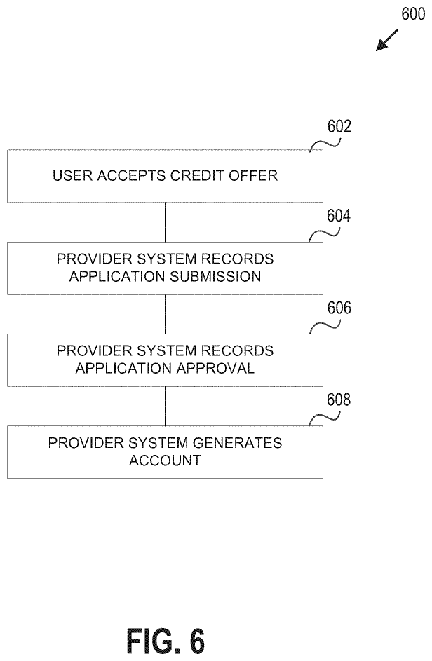

FIG. 6 is a flow diagram of a process 600 to open an account for a client based on a transparent underwriting process. This process can include a process in which an account is generated and tied to a client through a single user action (e.g., a single click on a client interface).

The process can include detecting that the user has accepted a credit offer (or a product) (block 602). This can include detecting a single action on a client interface indicating a request to open an account for the selected product. The provider can utilize previously-retrieved client information to open a new account for the client efficiently and accurately.

In some embodiments, the process can include retrieving a client identifier (ID) and product information. The product information can include information relating to a product, such as the new account to be opened for a client. For instance, this can include account terms, restrictions, etc. The product information can include information to generate an account number for the new account.

The process can include the provider system recording the application submission (block 604). All application submissions may be pre-underwritten using the processes as described herein. The application submission can be stored in relevant databases for a decision to be made as to whether the client is approved for the application. The system can process the client data and product data to determine whether the client is approved for a product.

The process can include the provider system recording an application approval (block 606). This can include storing relevant data and initiating the new account creation process.

The process can include the provider system generating the new account (block 608). This can include mapping the newly-created account to the client ID using the product information. Particularly, the system can add an entry in an account database to include the new account and the client ID. The new account can be generated using the product information.

In some embodiments, the process can include providing an account opening message to the client. The account opening message can include a message or a client interface indicating to the client that the new account has been opened. This message can include various account information relating to the user.

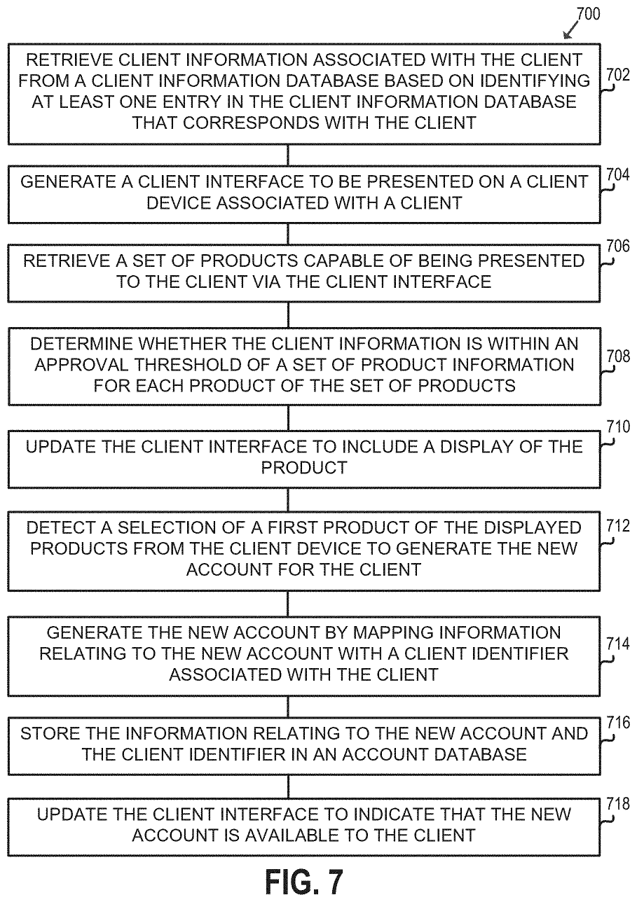

FIG. 7 illustrates an example method 700 for dynamic creation of a new account for a client. The method can include retrieving client information associated with the client from a client information database based on identifying at least one entry in the client information database that corresponds with the client (block 702).

In some embodiments, the method can include transmitting a request for client information to multiple third-party devices, wherein the request is encrypted and includes the client identifier. The method can also include receiving requested client information from the multiple third-party devices. The method can also include deriving a type of information included in the requested client information. The method can also include storing the requested client information in the client information database based on the derived type of information of the requested client information.

The method can also include generating a client interface to be presented on a client device associated with a client (block 704). The client interface can include the retrieved client information.

In some embodiments, the client interface includes a series of buttons indicative of no application account tasks capable of being performed for the client, and wherein the single action includes a selection of a first button of the series of buttons on the client interface corresponding to generating the new account.

The method can also include retrieving a set of products capable of being presented to the client via the client interface (block 706). The method can also include, for each product of the first set of products, determining whether the client information is within an approval threshold of a set of product information for each product of the set of products (block 708).

In some embodiments, determining whether the client information is within the approval threshold of the first set of product information for the first product further includes. inspecting the client information and the first set of product information to identify a number of subsets of client information that correspond to each type of product information included in the first set of product information. Determining whether the client information is within the approval threshold of the first set of product information for the first product also can include determining whether values included in each subset of client information exceed a threshold value range for each type of product information included in the first set of product information.

Determining whether the client information is within the approval threshold of the first set of product information for the first product can also include determining whether a number of instances of values included in each subset of client information that exceeds the threshold value range for each type of product information included in the first set of product information is greater than a threshold number, wherein the client information is within the approval threshold of the first set of product information for the first product when the number of instances of values included in each subset of client information that exceeds the threshold value range for each type of product information included in the first set of product information is greater than the threshold number.

The method can also include, responsive to determining that the client information is within the approval threshold of the set of product information for any product of the set of products, updating the client interface to include a display of the product (block 710).

The method can also include detecting a selection of a first product of the displayed products from the client device to generate the new account for the client (block 712). The method can also include generating the new account by mapping information relating to the new account with a client identifier associated with the client (block 714).

In some embodiments, generating the new account further includes populating account description fields using client information maintained by the client information database.

The method can also include storing the information relating to the new account and the client identifier in an account database (block 716). The method can also include updating the client interface to indicate that the new account is available to the client (block 718).

In some embodiments, the method can include presenting a subset of products on the client interface in an order, the first product included in the subset of products, wherein the client information is within approval thresholds of product information for each product of the subset of products.

In some embodiments, the order of the subset of products is based on a priority value assigned to each product of the subset of products.

In some embodiments, the method can include deriving the order of the subset of products based on the product information for each product of the subset of products based on a relevance of each product to the client information and a rating of each product.

In some embodiments, the method can include detecting an indication on the client interface indicating a request for presentation of products on the client interface. The method can also include setting a flag associated with the client identifier, wherein updating the client interface to include a display of the first product that is capable of being selected by the client is performed responsive to identifying the flag associated with the client identifier.

### Example Processing System

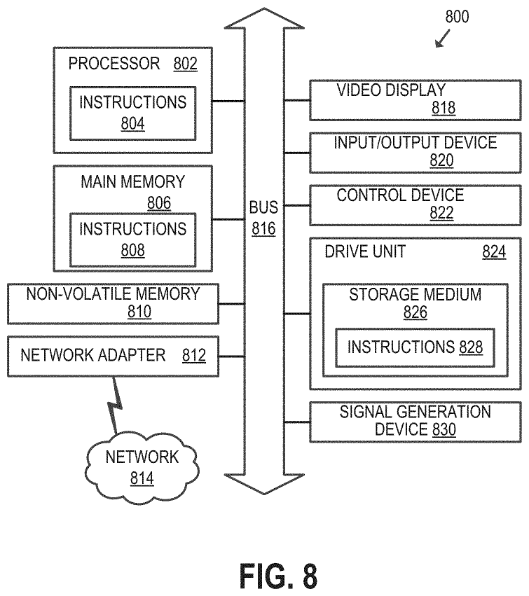

FIG. 8 is a block diagram illustrating an example of a processing system in which at least some operations described herein can be implemented. For example, some components of the processing system 800 can be hosted on an electronic device as described in the present embodiments.

The processing system 800 can include one or more central processing units (“processors”) 802, main memory 806, non-volatile memory 810, network adapter 812 (e.g., network interface), video display 818, input/output devices 820, control device 822 (e.g., keyboard and pointing devices), drive unit 824 including a storage medium 826, and signal generation device 830 that are communicatively connected to a bus 816. The bus 816 is illustrated as an abstraction that represents one or more physical buses and/or point-to-point connections that are connected by appropriate bridges, adapters, or controllers. The bus 816, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (i.e., “Firewire”).

The processing system 800 can share a similar computer processor architecture as that of a desktop computer, tablet computer, personal digital assistant (PDA), smartphone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 800.

While the main memory 806, non-volatile memory 810, and storage medium 826 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 828. The term “machine-readable medium” and “storage medium” shall also be taken to include any medium that is capable of storing, encoding, or carrying a set of instructions for execution by the processing system 800.

In general, the routines executed to implement the embodiments of the disclosure can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in a computing device. When read and executed by the one or more processors 802, the instruction(s) cause the processing system 800 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 810, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 812 enables the processing system 800 to mediate data in a network 814 with an entity that is external to the processing system 800 through any communication protocol supported by the processing system 800 and the external entity. The network adapter 812 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 812 can include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The techniques disclosed herein can include a tool or system to extract information from a design drawing to supplement the capabilities of a product manufacturing process. The present embodiments can assist in the generation/modification of a quote/estimate, the generation of manufacture feedback, the manufacturing scheduling/ordering process, etc.

### Remarks

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

What is claimed is:

1. A computer-implemented method comprising:
retrieving client information associated with a client from a client information database based on identifying at least one entry in the client information database that corresponds with the client;
generating a client interface to be presented on a client device associated with the client;
retrieving a set of products capable of being presented to the client via the client interface;
for each product of the first set of products, determining whether the client information is within an approval threshold of a set of product information for each product of the set of products;
responsive to determining that the client information is within the approval threshold of the set of product information for any product of the set of products, updating the client interface to include a display of the product;
detecting a selection of a first product of the displayed products from the client device to generate a new account for the client;
generating the new account by mapping information relating to the new account with a client identifier associated with the client;
storing the information relating to the new account and the client identifier in an account database; and
updating the client interface to indicate that the new account is available to the client.

2. The computer-implemented method of claim 1, further comprising:
transmitting a request for client information to multiple third-party devices, wherein the request is encrypted and includes the client identifier;
receiving requested client information from the multiple third-party devices;
deriving a type of information included in the requested client information; and
storing the requested client information in the client information database based on the derived type of information of the requested client information.

3. The computer-implemented method of claim 1, wherein generating the new account further includes populating account description fields using client information maintained by the client information database.

4. The computer-implemented method of claim 1, further comprising:
presenting a subset of products on the client interface in an order, the first product included in the subset of products, wherein the client information is within approval thresholds of product information for each product of the subset of products.

5. The computer-implemented method of claim 4, further comprising:
deriving the order of the subset of products based on the product information for each product of the subset of products based on a relevance of each product to the client information and a rating of each product.

6. The computer-implemented method of claim 1, further comprising:
inspecting the client information and a first set of product information relating to the first product to identify a number of subsets of client information that correspond to each type of product information included in the first set of product information;
determining whether values included in each subset of client information exceed a threshold value range for each type of product information included in the first set of product information; and
determining whether a number of instances of values included in each subset of client information that exceeds the threshold value range for each type of product information included in the first set of product information is greater than a threshold number, wherein the client information is within the approval threshold of the first set of product information for the first product when the number of instances of values included in each subset of client information that exceeds the threshold value range for each type of product information included in the first set of product information is greater than the threshold number.

7. A non-transitory machine-readable medium having machine executable instructions stored thereon that, when executed by one or more processors, direct the one or more processors to perform a method comprising:
retrieving client information associated with a client from a client information database based on identifying at least one entry in the client information database that corresponds with the client;
generating a client interface to be presented on a client device associated with the client, the client interface including the retrieved client information;
retrieving a set of products capable of being presented to the client via the client interface;
for each product of the first set of products, determining whether the client information is within an approval threshold of a set of product information for each product of the set of products; and
responsive to determining that the client information is within the approval threshold of the set of product information for any product of the set of products, updating the client interface to include a display of the product.

8. The non-transitory machine-readable medium of claim 7, further comprising:
detecting a selection of a first product of the displayed products from the client device to generate a new account for the client;
generating the new account by mapping information relating to the new account with a client identifier associated with the client;
storing the information relating to the new account and the client identifier in an account database; and
updating the client interface to indicate that the new account is available to the client.

9. The non-transitory machine-readable medium of claim 7, further comprising:
presenting a subset of products on the client interface in an order, the first product included in the subset of products, wherein the client information is within approval thresholds of product information for each product of the subset of products.

10. The non-transitory machine-readable medium of claim 9, further comprising:
deriving the order of the subset of products based on the product information for each product of the subset of products based on a relevance of each product to the client information and a rating of each product.

11. The non-transitory machine-readable medium of claim 7, further comprising:
inspecting the client information and a first set of product information relating to the first product to identify a number of subsets of client information that correspond to each type of product information included in the first set of product information;
determining whether values included in each subset of client information exceed a threshold value range for each type of product information included in the first set of product information; and
determining whether a number of instances of values included in each subset of client information that exceeds the threshold value range for each type of product information included in the first set of product information is greater than a threshold number, wherein the client information is within the approval threshold of the first set of product information for the first product when the number of instances of values included in each subset of client information that exceeds the threshold value range for each type of product information included in the first set of product information is greater than the threshold number.

12. The non-transitory machine-readable medium of claim 7, wherein generating the new account further includes populating account description fields using client information maintained by the client information database.

13. A system for dynamic creation of a new account for a client, the system comprising:
a server configured to:
retrieve client information associated with the client from a client information database based on identifying at least one entry in the client information database that corresponds with the client;
instruct a client device to present a client interface on the client device associated with the client, the client interface including the retrieved client information;
retrieve a set of products capable of being presented to the client via the client interface;
for each product of the first set of products, determine whether the client information is within an approval threshold of a set of product information for each product of the set of products;
responsive to determining that the client information is within the approval threshold of the set of product information for any product of the set of products, update the client interface to include a display of the product;
detect a selection of a first product of the displayed products from the client device to generate the new account for the client;
generate the new account by mapping information relating to the new account with a client identifier associated with the client;
store the information relating to the new account and the client identifier in an account database; and
instruct the client device to update the client interface to indicate that the new account is available to the client.

14. The system of claim 13, wherein the server is further configured to:
transmit a request for client information to multiple third-party devices, wherein the request is encrypted and includes the client identifier;
receive the requested client information from the multiple third-party devices;
derive a type of information included in the requested client information; and
store the requested client information in the client information database based on the derived type of information of the requested client information.

15. The system of claim 13, wherein generating the new account further includes populating account description fields using client information maintained by the client information database.

16. The system of claim 13, wherein the server is further configured to:
present a subset of products on the client interface in an order, the first product included in the subset of products, wherein the client information is within approval thresholds of product information for each product of the subset of products.

17. The system of claim 16, wherein the server is further configured to:
derive the order of the subset of products based on the product information for each product of the subset of products based on a relevance of each product to the client information and a rating of each product.

18. The system of claim 17, wherein the order of the subset of products is based on a priority value assigned to each product of the subset of products.

19. The system of claim 13, wherein the server is further configured to:
inspect the client information and a first set of product information relating to the first product to identify a number of subsets of client information that correspond to each type of product information included in the first set of product information;
determine whether values included in each subset of client information exceed a threshold value range for each type of product information included in the first set of product information; and
determine whether a number of instances of values included in each subset of client information that exceeds the threshold value range for each type of product information included in the first set of product information is greater than a threshold number, wherein the client information is within the approval threshold of the first set of product information for the first product when the number of instances of values included in each subset of client information that exceeds the threshold value range for each type of product information included in the first set of product information is greater than the threshold number.

20. A method performed by a network-accessible server system for automatically providing approved products to a client via a client interface, the method comprising:
retrieving client information associated with a client from a client information database based on identifying at least one entry in the client information database that corresponds with the client;
generating a client interface to be presented on a client device associated with the client;
retrieving a set of products capable of being presented to the client via the client interface;
for each product of the first set of products, determining whether the client information is within an approval threshold of a set of product information for each product of the set of products; and
responsive to determining that the client information is within the approval threshold of the set of product information for any product of the set of products, updating the client interface to include a display of the product.
